(19) United States
(12) Patent Application Publication
(10) Pub. No.: US 2009/0013847 A1
(43) Pub. Date: Jan. 15, 2009

(54) Toothed saw blade with a variable pitch

(76) Inventor: Maurice Lauzet, Chenecey Buillon (FR)

Correspondence Address: Cohen, Gary M., Strafford Building Number Three, 125 Strafford Avenue, Suite 300, Wayne, PA, 19087-3318, US

(21) Appl. No.: 11/665,035

(22) PCT Filed: Oct. 7, 2005
(86) PCT No.: PCT/FR05/02472

§ 371 Date: Apr. 10, 2007

(30) Foreign Application Priority Data
Oct. 15, 2004 (FR) 0410892

(51) Int. Cl. B27B 33/02

(52) U.S. Cl. 83/846

(57) ABSTRACT

Saw blade (1) with evolutionary tooth profile and different pitch, characterized in that said triple-bevel blade is divided into sectors (2), themselves divided into portions (3), each portion (3) having a different pitch which increases progressively from portion (3) to portion (3), the depth of the teeth also varying over several portions.

The present invention relates to a saw blade with evolutionary tooth profile and variable pitch.

Saw blades may have different tooth profiles according to the material to be handled and the type of work to be carried out. Hence, tooth profiles for saw blades intended to work wood or soft materials are generally based on a dual bevel or triple bevel design. They give good performance but are highly specialized in terms of the pitch of the tooth profile, and are therefore restricted to a specific task.

Furthermore, the finer pitches on the tooth profile of a saw blade allow precision work in hardwoods such as parquets, whereas the coarser pitches offer a high work rate for rougher work that requires less precision.

U.S. Pat. No. 2,568,870 describes in particular a saw blade in which the size of the teeth and the pitch of the tooth profile increase progressively in one sector, then decrease progressively in the next sector.

U.S. Pat. No. 4,179,967 for its part describes a saw blade in which the pitch decreases progressively in one sector and repeats in the same form in the next sector.

Patent US 2002 029670 describes in particular a saw blade in which the pitch of the teeth and the size of the teeth can vary.

However, this type of saw does not allow work to be carried out both quickly and accurately, without changing saw, nor does it allow the cut to be started easily and uniformly. This is because triple bevel tooth profiles have just one type of pitch per blade, thus reducing the scope of applications for which this type of saw can be used.

The invention proposes to remedy this disadvantage using a multifunction handsaw blade tooth profile that allows both precise cutting and a high work rate while using a single saw blade and at the same time avoiding jerkiness when cutting the wood in all its forms, thanks to an ease of starting permitted by a fine tooth profile followed by a coarser tooth profile intended to allow a high cutting rate.

To this end, a subject of the present invention is a saw blade divided into successive sectors corresponding to a tooth profile that is evolutionary and of different pitch, characterized in that the tooth profile of said blade is a triple bevel profile and in that each sector is itself divided into portions, each portion having a different pitch which increases progressively from one portion to the next, the depth of the teeth also varying from one portion to another.

The saw blade consists of teeth with different pitches, the pitch in fact being the distance between the tips of two consecutive teeth. The idea of number of teeth per unit length, known as teeth per inch, may also be used in the remainder of the description, this parameter being the one customarily used in the technical field concerned. An inch is in fact an imperial unit measuring 2.54 centimeters.

The saw blade according to the invention has a tooth profile which is divided into sectors, themselves divided into portions. Each sector may repeat several times along the length of the blade. Furthermore, a sector may contain from one to five different portions, the portions corresponding to a type of tooth profile, the pitch of which is evolutionary and different.

The saw blade comprises a sector, the tooth profile of which has a fine pitch increasing progressively to a longer pitch. The sector is then repeated, and the tooth profile resumes at a finer pitch increasing progressively to a longer pitch. Each sector may be repeated and may be identical to the previous one or be different.

The invention will be better understood with reference to the attached drawings in which:

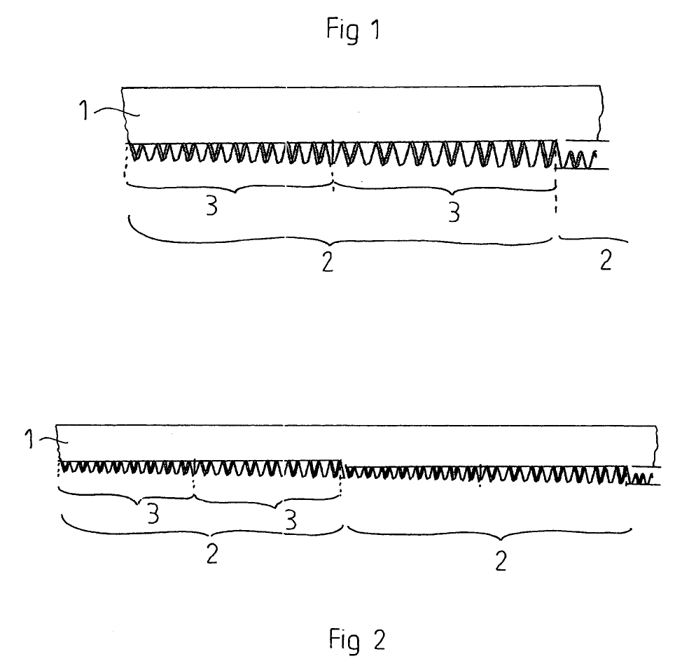

FIG. 1 depicts part of a saw blade

FIG. 2 depicts a saw blade in which the sectors are repeated several times.

The saw blade 1 has successive sectors 2 which may repeat along the entire length of the blade 1. These sectors 2 are themselves divided into portions 3. The sectors will have an average length of 50 millimeters in order to maintain the benefit of each type of pitch.

Each portion 3 has a different pitch increasing progressively from portion to portion. Furthermore, these portions have a profile that evolves in the depth of the teeth, making it possible to obtain a gradual change in the chip-removal capability and also making it possible to avoid jerkiness. The depth of the gap between teeth increases progressively over the entire length of the sector 2 formed by the portions 3, so as to improve chip removal.

By way of a non-limiting example, one and the same blade may have several sectors, each of these sectors being equipped with a portion which would have eleven teeth per inch over a given length, then a portion with nine teeth per inch over a second given length.

In addition, the tips of all the teeth are strictly at the same height, with no discontinuity, even when progressing from one portion to another, or progressing from one sector to another, making it possible to have a cutting rate that is uniform whether the material being worked is a hard material or a soft one. The teeth are, in effect, at the same height, even when progressing from one sector to the next.

The principle of progressiveness between the teeth means that there needs to be some link between the various pitches. As a result, the height of the first tooth corresponds to the height of the last tooth of the previous portion.

By way of example, for a blade that has a sector containing two portions, one with nine teeth per inch and the second with seven teeth per inch, and therefore for progression of two teeth per inch between two portions, the depth of the first of the teeth at a pitch of nine teeth per inch will be equal to the depth of a triple bevel tooth at a pitch of eleven teeth per inch (to be verified).

This principle is the same regardless of the pitch of the teeth, for example when progressing between two portions, one of nine teeth per inch to another of seven teeth per inch.

Furthermore, for esthetic reasons, the second tooth of the same height will be eliminated in order to have perfect continuity along the entire length of the saw blade.

As can be seen in the drawings, at the start of the sector 2, corresponding to a first portion 3, the pitch of the tooth profile is short with a larger interior angle, therefore a low angle of attack relative to the material. This pitch increases progressively while the angle of attack increases in parallel.

Furthermore, in parallel with the increase in tooth size, the depth of these teeth also increases progressively.

The progressiveness encountered along the length of the saw blade therefore leads to a change in the angle at which the tooth attacks the material. As this angle is smaller on the smaller-size teeth, the effort needed to initiate cutting of the material is also less. This effort increases progressively with the reduction in angle, ensuring that the saw cuts without jerkiness.

In addition, starting the cut using small teeth is known to be easier, regardless of the type of material, be it hard or soft, because the small teeth bite into the material gently and allow for a better start to the cut. This is because the larger angle at the small teeth gives a broader tooth base, giving better integrity over time and also better rigidity, particularly in terms of the setting of the saw.

Furthermore, the progression from one sector 2 to another exhibits no discontinuity being, by contrast, continuous. This in particular avoids any catching in the material being cut, making cutting all the easier, and also all the quicker since it is more uniform.

In order to obtain a saw blade with a high degree of multifunctionality, this saw blade may have several portions, preferably from two to five portions, each portion having a variable and evolutionary pitch.

Furthermore, the portions may have different widths and pitches making it possible to obtain a saw blade able to cover a wide variety of types of work. By way of example, a difference of two to three teeth per inch between two consecutive portions makes it possible to obtain a fairly wide variation in the type of work that can be performed.

In addition, the variation in pitch between portions may be achieved with a difference of one to three teeth per inch, mainly one to three teeth per 2.54 centimeters.

Thus, for example, a blade may have a profile with seven teeth per inch but in which the tip has a sector beginning with eleven teeth per inch gradually reducing to seven teeth per inch. This type of sector with a fine tooth profile allows for a better start to the cut because this type of pitch prevents the jumping that may be experienced with blades of seven teeth per inch.

This type of tooth profile can be applied to saws with conventional tooth profiles, but can also be applied to crosscut saws. It may also be applied to dual bevel or triple bevel saw blades. In the case of triple bevel tooth profiles, the evolutionary region is placed at the start of the blade in order to make the starting cut easier.

Furthermore, the pitch of this type of saw blade may vary from 1.5 to 8.5 millimeters, thus giving a wide scope of types of saw blades.

The cutting angle may vary from 25 to 35 degrees with respect to the perpendicular to the blade.

However the operator works, he will at numerous points along the blade find a fine-toothed sector with which he can begin his cut with ease.

In addition, the sectors provide a large number of teeth in contact with the wooden workpiece, making the work gentler as the amount of jerkiness is limited.

1. A saw blade (1) divided into successive sectors (2) corresponding to a tooth profile that is evolutionary and of different pitch, characterized in that the tooth profile of said blade is a triple bevel profile and in that each sector (2) is itself divided into portions (3), each portion (3) having a different pitch which increases progressively from one portion (3) to the next, the depth of the teeth also varying from one portion (3) to another.

2. The saw blade (1) as claimed in claim 1, characterized in that the tips of the teeth of said blade are positioned at the same height along the entire length of the blade.

3. The saw blade (1) as claimed in one of the preceding claims, characterized in that each sector (2) comprises from two to five portions (3).

4. The saw blade (1) as claimed in one of the preceding claims, characterized in that the angle of attack varies according to the pitch of the portion (3).

5. The saw blade (1) as claimed in one of the preceding claims, characterized in that the length of the portions (3) can vary.

6. The saw blade (1) as claimed in one of the preceding claims, characterized in that the variation in pitch between each portion (3) is from 1 to 3 teeth per 2.54 centimeters.

7. The saw blade (1) as claimed in one of the preceding claims, characterized in that the pitch varies from 1.5 to 8.5 millimeters.

8. The saw blade (L) as claimed in one of the preceding claims, characterized in that the cutting angle ranges between 25 and 35°.

9. The saw blade (1) as claimed in one of the preceding claims, characterized in that it consists of a single sector (1).

10. The saw blade (1) as claimed in one of the preceding claims, characterized in that it has a crosscut tooth profile.

11. The saw blade as claimed in one of the preceding claims, characterized in that the length of a sector (2) is 50 millimeters.
